(19) United States
(12) Patent Application Publication
(10) Pub. No.: US 2016/0321884 A1
(43) Pub. Date: Nov. 3, 2016

(54) MERCHANDISE SECURITY DEVICE HAVING ELECTRO MECHANICAL ACTUATOR AND METHOD OF USE

(71) Applicants: Peter Bremer, Beerfelden (DE); Peter Schneider, Wilhelmsfeld (DE)

(72) Inventors: Peter Bremer, Beerfelden (DE); Peter Schneider, Wilhelmsfeld (DE)

(21) Appl. No.: 14/702,384

(22) Filed: May 1, 2015

(51) Int. Cl. G08B 13/06

(52) U.S. Cl. CPC G08B 13/06

(57) ABSTRACT

A security device includes a body housing having a receptacle configured to receive a coupler to affix the body housing to an article of merchandise; a locking mechanism configured to maintain the coupler in a fixed position with respect to the body housing and in retaining engagement with the article of merchandise; and an electro-mechanical actuator configured to alter from a first state to a second state in response to application of an actuation voltage, wherein alteration of the electro-mechanical actuator from the first state to the second state enables the coupler to move with respect to the body housing.

### FIELD OF THE INVENTION

The field of the present invention relates to security devices for merchandise, and particularly to security devices which are attached to merchandise and intended to be removed at the time of a sales transaction.

### BACKGROUND OF THE INVENTION

Theft-deterrent security devices are attached to articles of merchandise for deterring the theft of the merchandise. Such security devices are often detected by sensors placed at points of egress from a premises so that an alarm may be produced, whether audible or silent, if an article having a security device still attached is removed from monitored premises. In one example, the security device may be attached to the merchandise using a two-part housing, with each part of the housing being placed on opposite sides of a portion of the merchandise, e.g., on opposite sides of a piece of cloth, and the two parts being locked together to prevent unauthorized removal of the security device from the merchandise. In this example, a common way to attach a security device to merchandise is by having a pin which extends from one of the housing parts to be securely received and engaged by the other housing part. With such a security device, the pin is passed through a portion of the merchandise so that the two housing parts are secured to each other and cannot be removed without a specialized tool. A security device, however, may be attached to merchandise via many and various other means, e.g., via a cable, a cap, etc.

The types of specialized tools for removing a security device are almost as numerous as the types of security devices. Security devices that may be removed with magnetic tools are known, as are security devices that may be removed with specialized mechanical tools. The removal tools, however, become a point of weakness in the overall anti-theft system, because they may be obtained and used by unauthorized individuals. In order to eliminate this weakness, and to introduce an added element of convenience to removing security devices from merchandise, a new design for security devices is needed, particularly in the way the security devices are attached to and removed from merchandise.

### SUMMARY OF THE INVENTION

The present invention is directed toward a security device which is particularly useful as a theft deterrent for articles of merchandise. The present invention is further directed toward the use of such a security device. Merchants who already employ radio frequency identification (RFID) at the point of sale, whether for inventory tracking purposes or otherwise, may remove the security device from an article of merchandise using the RFID scanner already in place at the point of sale (POS). Therefore, such merchants may remove the security device without any additional specialized equipment.

In a first separate aspect of the present invention, a security device includes: a body housing configured to receive a coupler to affix the body housing to an article of merchandise; a locking mechanism configured to maintain the coupler in a fixed position with respect to the body housing and in retaining engagement with the article of merchandise; and an electro-mechanical actuator configured to alter from a first state to a second state in response to application of an actuation voltage, wherein alteration of the electro-mechanical actuator from the first state to the second state enables the coupler to move with respect to the body housing.

In a second separate aspect of the present invention, a method of detaching a security device from an article of merchandise includes: directing a signal into the security device, the security device including: a body housing; a coupler engaged with the article of merchandise and received in the body housing; a locking mechanism configured to maintain the coupler in a fixed position with respect to the body housing and in retaining engagement with the article of merchandise; and an electro-mechanical actuator configured to alter from a first state to a second state, wherein alteration of the electro-mechanical actuator from the first state to the second state enables the coupler to move with respect to the body housing; wherein the signal causes the electro-mechanical actuator to alter from the first state to the second state; and disengaging the coupler from the article of merchandise.

In a third separate aspect of the present invention, a security device includes: a pin configured for engagement with an article of merchandise; a body housing having a receptacle configured to receive the pin when the pin is engaged with the article of merchandise; a locking mechanism configured to maintain the pin in a fixed position with respect to the receptacle and in retaining engagement with the article of merchandise; and an electro-active polymer element configured to alter from a first dimensional size to a second dimensional size in response to application of an actuation voltage, the second dimensional size being different from the first dimensional size, wherein alteration of the electro-active polymer element from the first dimensional size to the second dimensional size enables the pin to translate along a lateral axis with respect to the receptacle.

Accordingly, an improved security device and method of detaching a security device are disclosed. Advantages of the improvements will be apparent from the drawings and the description of the preferred embodiment.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 is a schematic block diagram of a first exemplary security device;

FIG. 2 is a schematic block diagram of a first exemplary security device system;

FIG. 3 is a flow chart showing the detachment process for a security device;

FIG. 4 is a side elevation view of a first embodiment of a security device;

FIG. 5 is a sectional view of the security device of FIG. 4, having an electroactive polymer as an electro-mechanical actuator for disengaging the locking mechanism;

FIGS. 6A and 6B schematically illustrate deformation of an electroactive polymer;

FIG. 7 is a sectional view of a second embodiment of a security device having an electroactive polymer as an electro-mechanical actuator for disengaging the locking mechanism;

FIG. 8 is a perspective view of a second exemplary security device in a locked position on a bottle;

FIG. 9 is an exploded view of the security device of FIG. 8;

FIG. 10 is a sectional view of the security device of FIG. 8 in a locked position;

FIG. 11 is an enlarged sectional view of the indicated portion of FIG. 10 showing the locking mechanism;

FIG. 12 is a top perspective view of a third exemplary security device;

FIG. 13 is a top plan view of the security device of FIG. 12 with the locking clip being positioned for insertion into the body housing;

FIG. 14 is a fragmentary top plan view showing the clip being inserted into the body housing of the security device;

FIG. 15 is a fragmentary sectional view, along the line A-A of FIG. 14, showing the clip being inserted into the body housing of the security device of FIG. 14;

FIG. 16 is a fragmentary sectional view showing the clip fully inserted into the body housing of the security device of FIG. 14; and

FIG. 17 is a fragmentary sectional view showing the locking mechanism of the security device of FIG. 14.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combinations of features that may exist alone or in other combinations of features; the scope of the invention being defined by the claims appended hereto.

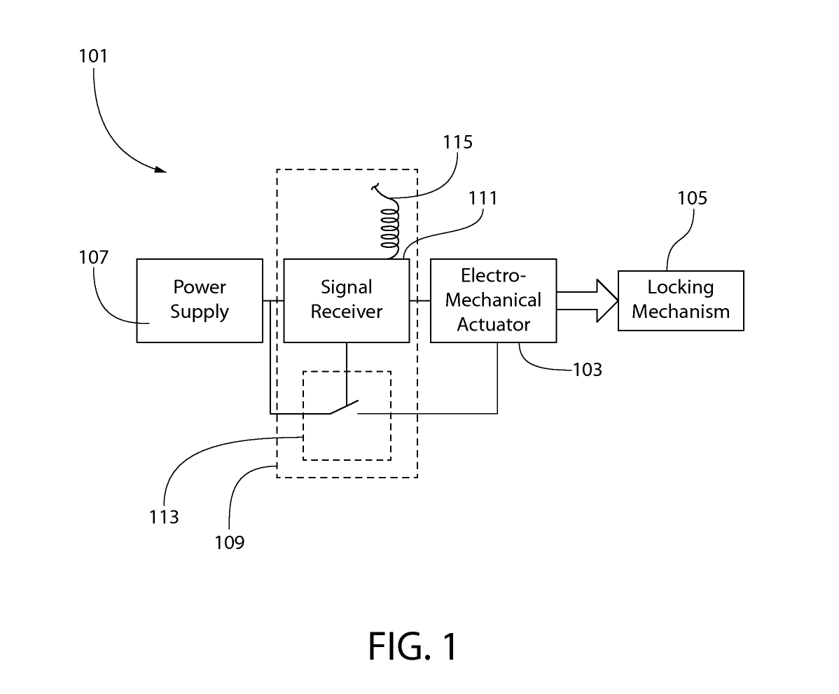

Turning in detail to the drawings, FIG. 1 schematically illustrates functional electrical and electro-mechanical parts of one embodiment of a security device 101 which may be secured to an article of merchandise. The security device 101 includes an electro-mechanical actuator 103, which physically interacts with a locking mechanism 105, a power source 107, and a switching circuit 109, which includes a signal receiver 111 electrically coupled to a switch 113. The electro-mechanical actuator 103 interacts with the locking mechanism to serve as a lock for the locking mechanism or as a device to unlock the locking mechanism.

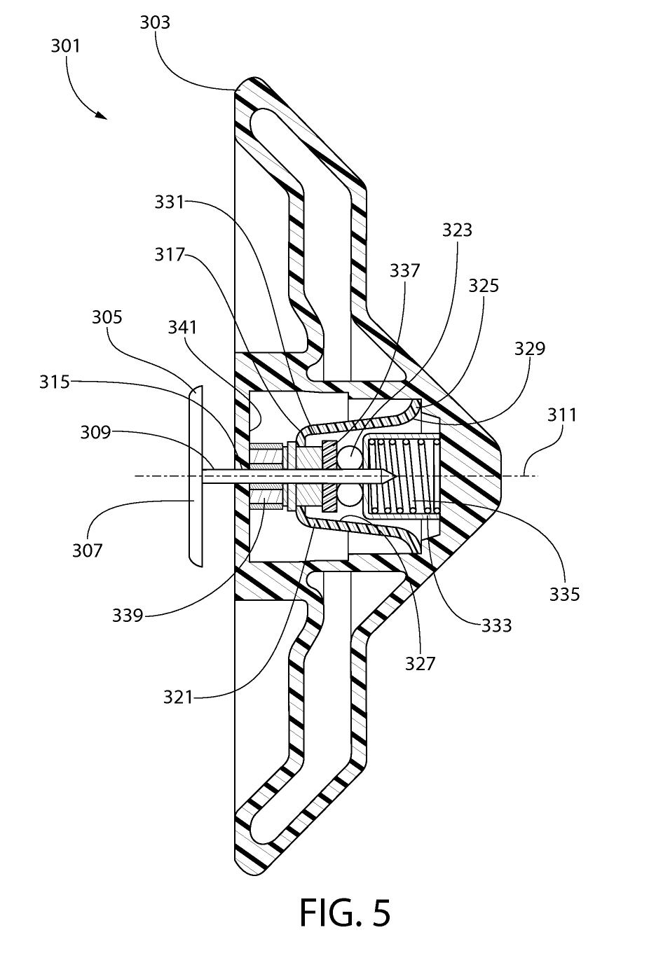

As described in further detail below, in one example, the locking mechanism in a locked state may be configured to maintain a coupler in a fixed position with respect to a receptacle in a body housing of the security device, with the coupler being in retaining engagement with an article of merchandise. In this example, when the coupler is in the unlocked state, the coupler is disengaged/disengageable from the locking mechanism, so that the coupler may be disengaged from the article of merchandise. As a lock for the locking mechanism, the electro-mechanical actuator 103 may serve to prevent the locking mechanism from being moved from a locked state to an unlocked state. As a device to unlock the locking mechanism, the electro-mechanical actuator 103 may serve to actively actuate the locking mechanism. The electro-mechanical actuator 103 may be of any type appropriate for the particular implementation of the security device 101. For example, the security device shown in FIG. 5 shows the electro-mechanical actuator as an electro-active polymer element 339, which is capable of altering from a first state (i.e., a first physical configuration) to a second state (i.e., a second physical configuration). In other embodiments, depending upon the configuration of the security device, the electro-mechanical actuator 103 may be a electromagnetic actuator, a squiggle motor, or any other electro-mechanical device that is activated by an electric signal (such as a voltage differential) and thereby causes a physical action or displacement. Other types of electro-mechanical actuators may be employed either to prevent the locking mechanism from being moved from an unlocked state to a locked state or to unlock the locking mechanism.

The switching circuit 109 includes an antenna 115 to receive wireless signals, with the antenna being electrically coupled to the signal receiver 111. Receipt of an appropriate wireless signal triggers the signal receiver 111 to actuate the switch 113, thereby electrically coupling the power source 107 to the electro-mechanical actuator 103. Many different types of wireless signals (e.g., RFID, Bluetooth, etc.) may be appropriate for causing the signal receiver 111 to actuate the switch 113. The power source 107, for example, may be internal or external to the security device 101, regardless of whether the signal receiver 111 is configured to receive a wireless signal or a wired signal. For embodiments in which the power source 107 is internal, actuation of the switch 113 electrically couples the power source 107 to the electro-mechanical actuator 103. For embodiments in which the power source 107 is external, actuation of the switch 113 enables the power source 107 to connect and provide power to the electro-mechanical actuator 103.

During operation of the security device 101 of FIG. 1, a wireless signal may be directed to the signal receiver 111. In one example, receipt of the wireless signal causes the signal receiver 111 to actuate the switch 113, thereby electrically coupling the power source 107 to the electro-mechanical actuator 103. Upon being connected to the power source 107, the electro-mechanical actuator 103 alters from a first state to a second state. This alteration of the electro-mechanical actuator 103 from the first state to the second state may either unlock the locking mechanism, or enable a user to move the locking mechanism from a locked state to an unlocked state. In this manner, the wireless signal causes the electro-mechanical actuator 103 to alter from the first state to the second state. In example using a coupler, once the electro-mechanical actuator 103 is altered from the first state to the second state, the coupler may be disengaged or may become disengageable from the locking mechanism, thereby making it possible for a user to disengage the coupler from the article of merchandise.

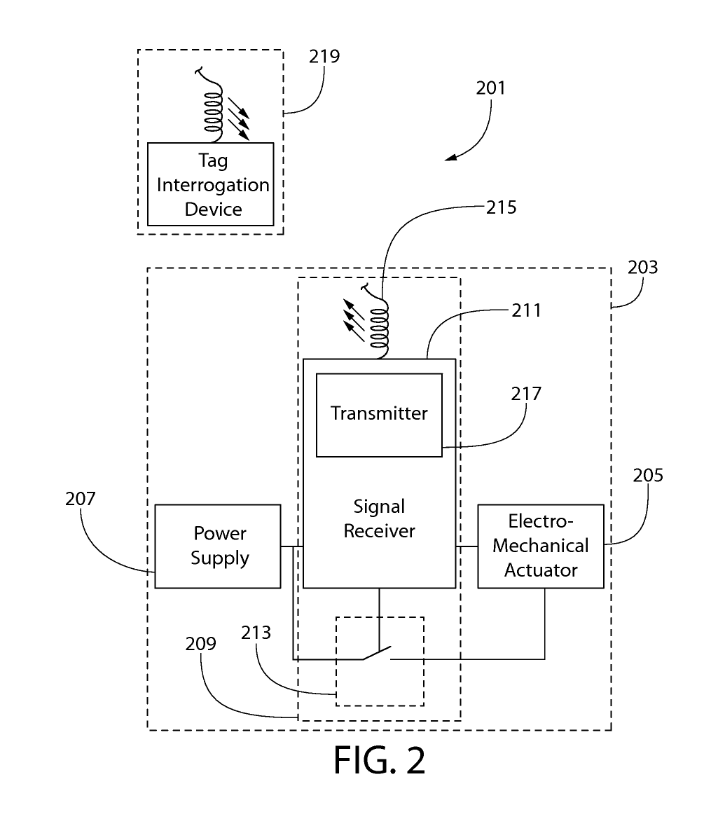

In the embodiment shown in FIG. 2, the functional electrical and electro-mechanical parts of a security device system 201 and a security device 203 are illustrated. The security device 203 includes an electro-mechanical actuator 205, which physically interacts with a locking mechanism, a power source 207, and a switching circuit 209, which includes a signal receiver 211 electrically coupled to a switch 213. The electro-mechanical actuator 205 interacts with the locking mechanism to serve as a lock for the locking mechanism or as a device to unlock the locking mechanism.

The switching circuit 209 includes an antenna 215 and the signal receiver 211 includes an activation element 217 (e.g., a radio frequency identification (RFID) element). The switch 213 is actuated upon the activation element 217 being wirelessly activated by a scanner/interrogation system 219, thereby electrically coupling the power source 207 to the electro-mechanical actuator 205. In certain other embodiments, the activation element 217 may be actuated upon receipt of a command signal (e.g., an RFID command signal) from the interrogation system. In yet other embodiments, the signal receiver may be electrically coupled to a specialized tool which transmits an appropriate signal into the signal receiver over the wired connection to cause the signal receiver to actuate the switch. In such embodiments, the signal may be an actuation voltage.

In certain embodiments, the release circuitry can be more sophisticated than the simple reception of a signal (e.g., an RF signal) at a single frequency. In such embodiments, the release may be conditioned on receipt, by the switching circuit, of a code broadcast at a carrier frequency (e.g., an RF carrier frequency) by any of various known means of modulation. The use of a code to trigger release of the security device reduces the chances of inadvertent release of a security device and enhances the user's ability to track removal of security devices from articles of merchandise. For example, a security device requiring reception of a unique identification code as part of an RF signal before release can be associated with an article of merchandise. In one example, a transmitter for sending a signal with the unique identification code can be connected to a cash register system and product identification hardware, such that the unique identification code associated with the article of merchandise is only transmitted when a valid sale transaction is recorded for the identified article of merchandise. Such a system would allow customers to remove security devices after they have paid for items at self-service checkout stations by sending the unique identification code once the product has been identified and paid for. Such a system might also beneficially also prevent theft by employees, by allowing the removal of security devices from articles of merchandise only when a legitimate purchase transaction exists (e.g., preventing the removal of the security device when the articles of merchandise have not been paid for).

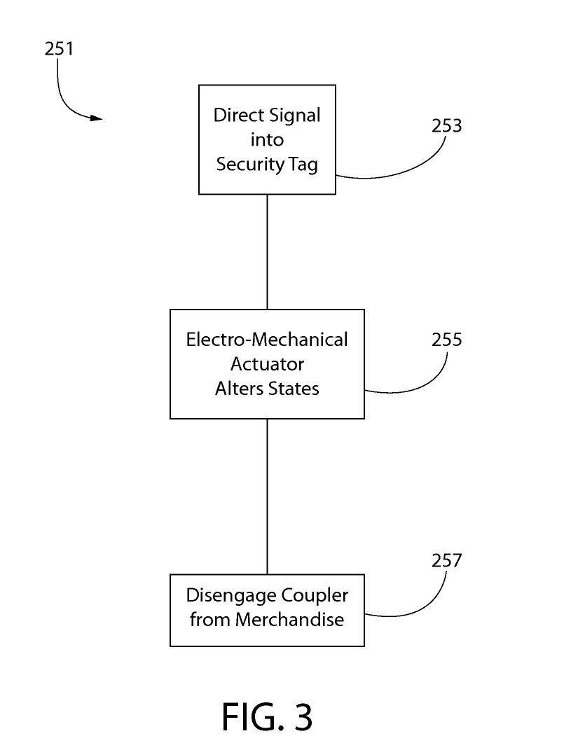

One embodiment of a detachment process 251 for a security device is shown in the flow chart of FIG. 3. This detachment process 251 is for an article of merchandise having a security device according to FIG. 1 attached thereto. The article of merchandise may be presented at a point of sale by a customer of a sales establishment, or, in other embodiments, a customer may purchase the article of merchandise using a portable device (e.g., a smartphone, scanner, etc.). After purchase of the merchandise (e.g., using a smartphone, at a point of sale, etc.), a signal is directed 253 into the security device. In one example, the security device may include a coupler engaged with the article of merchandise, a locking mechanism maintaining the coupler in a fixed position with respect to a receptacle in the body housing of the security device, and an electro-mechanical actuator which alters from a first state to a second state to enable the coupler to translate along a lateral axis with respect to the receptacle. In other examples, however, a cable, or other attachment means, may be used to affix the security device to the article of merchandise. For embodiments of the security device which include an element (e.g., an RFID element) actuating a switch to couple the electro-mechanical actuator to a power source, the signal directed 253 into the security device may be a radio frequency identification (RFID) signal from an RFID scanner. With the signal directed 253 into the security device, the signal causes the electro-mechanical actuator to alter 255 from the first state to the second state. Alteration of states by the electro-mechanical actuator may result directly in the disengagement of the coupler from the locking mechanism, or alternatively it may result in the locking mechanism being unlocked so that a user may actuate the locking mechanism manually to disengage the coupler therefrom. After the electro-mechanical actuator alters 255 states, the coupler may be disengaged 257 from the article of merchandise.

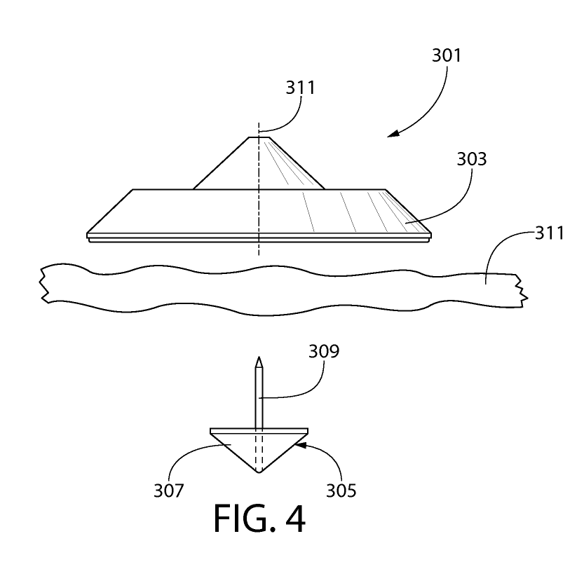

FIG. 4 illustrates one embodiment of a security device 301. In this embodiment, the security device 301 includes a body housing 303 and a coupler 305. Although the coupler is depicted in the form of a pin assembly 307 having a pin 309 in this embodiment, the coupler 305 may not require a pin 309 or pin assembly 307, and may include any means for attaching the security device to an article of merchandise. In the embodiment having a pin 309, the pin 309 is received into a receptacle (not shown in FIG. 4) in the body housing 303 by positioning the pin 309 adjacent the receptacle, aligning the pin 309 with a lateral axis 311 extending through the receptacle, and translating the pin assembly 307 toward the body housing 303 along the lateral axis 311 so that the pin 309 passes through the receptacle and into the body housing 303. Once received in the receptacle, the pin 309 is secured in a fixed position by a locking mechanism within the body housing 303. The security device 301 may be secured to an article of merchandise 313 by passing the pin 309 through the article of merchandise 313 before the pin 309 is inserted into the receptacle. Those of skill in the art will recognize that the body housing 303, coupler 305, and the locking mechanism may have any other desirable configuration without departing from the inventive concepts expressed in this disclosure.

FIG. 5 further depicts an embodiment of the security device wherein the coupler includes a pin 309 and pin assembly 307. In this embodiment, the pin assembly 307 is inserted into the receptacle 315 in the body housing 303. The pin 309 is aligned along a lateral axis 311 extending through the receptacle 315. Within the body housing 303, the pin 309 engages with a locking mechanism 317, which in the embodiment depicted is in the form of a ball clutch mechanism 321. The ball clutch mechanism 321 includes a plurality of balls 323 arranged in a tapered clutch housing 325 such that there is space for the pin 309 to be inserted into the tapered clutch housing 325 amongst the balls 323. The inside walls 327 of the tapered clutch housing 325 are tapered slightly such that the inside diameter of the tapered clutch housing 325 is smaller at the wide end 329 than at the narrow end 331. A plunger 333 in the wide end 329 is biased toward the narrow end 331 of the tapered clutch housing 325 by a spring 335, forcing the balls 323 toward the inserted pin 309. The size of the balls 323 and the dimensions of the tapered clutch housing 325 are such that the balls 323 tightly press against the pin 309 when they are forced toward the narrow end 331 by the plunger 333 and the spring 335. The ball clutch mechanism 321 is thus able to maintain the pin 309 in a fixed position with respect to the receptacle 315, and in doing so, the pin assembly 307 may remain in retaining engagement with the article of merchandise (not shown in FIG. 5).

In an embodiment having a ball clutch mechanism 321, the ball clutch mechanism 321 may also include a clutch release plate 337. The clutch release plate may extend through the narrow end 331 of the tapered clutch housing 325. Displacement of the clutch release plate 337 toward the wide end 329 of the tapered clutch housing 325 displaces the balls 323 away from the narrow end 331 of the tapered clutch housing 325. As the balls 323 are displaced toward the wide end 329 of the tapered clutch housing 325, they do not tightly press against the pin 309, so that the pin 309 may then be translated along the lateral axis 311, with respect to the receptacle 315, and removed from the body housing 303 with little effort. In this manner, the coupler 305 may be disengaged from the body housing 303, and therefore the coupler 305 may be disengaged from the article of merchandise.

The clutch release plate 337 may be displaced by an electro-active polymer element (EAP) 339. In other embodiments, as discussed above, other types of electromechanical actuators may be used to displace the clutch release plate 337. Electro-active polymers are polymers that exhibit a change in size or shape when stimulated by an electric field. Typically, an EAP is able to undergo a major deformation while providing a substantial force along the directions of deformation. When employing an EAP as an actuator capable of repeated uses (as opposed to a single use or limited numbers of uses), deformation of the EAP should be fully reversible and repeatable.

One type of EAP material is known as a dielectric electroactive polymer (DEAP). Some DEAPs are able to provide both repeatability and reversibility that are desired for use as an actuator. DEAPs are materials in which a deformation is caused by electrostatic forces on the DEAP material sandwiched between two electrodes. When an electric voltage is applied, an electrostatic pressure is exerted on the DEAP material, reducing the thickness and expanding the area of the DEAP material due to the applied electric field.

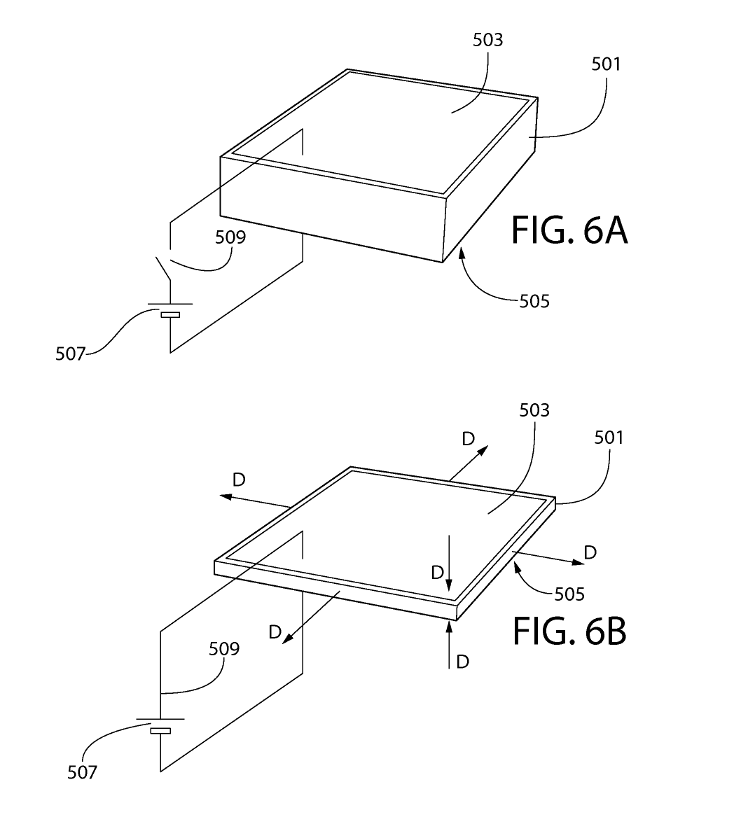

FIGS. 6A and 6B illustrate deformations that may be achieved, for example, using a DEAP material 501 placed between two plate electrodes (503, 505). Electro-mechanical actuators may be formed using a DEAP material, positioned between two electrodes, such that deformation of the DEAP material causes a displacement, and thereby, actuation. FIG. 6A shows the DEAP material 501 positioned between a first electrode 503 and a second electrode 505. The first electrode 503 is electrically coupled to a voltage source 507 through a switch 509, and the second electrode 505 is directly electrically coupled to the voltage source 507.

In FIG. 6A, the switch 509 is open so that no voltage differential is applied across the first and second electrodes (503, 505). With no voltage differential applied, the DEAP material 501 is in a first state, one in which it has a first dimensional size and is not deformed. In FIG. 6B, the switch 509 is closed so that a voltage differential is applied across the first and second electrodes (503, 505). With a voltage differential applied, the DEAP material 501 is in a second state, one in which it is deformed and has a second dimensional size. As is shown, the second dimensional size is different from the first dimensional size, and it is this difference in the two dimensional sizes, and the controlled alteration between the two states, that enables mechanical actuation of a clutch release plate in a security device. The deformations of the DEAP material, which create the differences in the two dimensional sizes, are illustrated by the arrows D in FIG. 6B.

To achieve the alteration between the first state of the DEAP material and the second state of the DEAP material, an actuation voltage is applied to one of the first and second electrodes (503, 505), while the other electrode is electrically coupled to a ground. The amount of voltage needed to cause deformation of the DEAP material will vary depending upon the thickness of the DEAP material, the size and form of the two electrodes, the amount of deformation needed for the mechanical actuation, i.e. how much displacement is required in the actuator design to enable the coupler to disengage from the locking mechanism.

In the context of the security device 301 shown in FIG. 5, a DEAP material positioned between two electrodes may be used as the electro-active polymer element 339 to displace the clutch release plate 337, for example. In this example, leads may connect each electrode to a power source that is either internal or external to the security device 301, with one of the leads being switched in a manner described above. One of skill in the art will recognize that the electro-active polymer element 339 should be designed and positioned such that expansion of the DEAP material causes displacement of the clutch release plate 337. For example, both electrodes of the electro-active polymer element 339 may be positioned orthogonal to a top surface of the clutch release plate 337, against which the electro-active polymer element 339 bears. In such configuration, when the actuation voltage is applied across the electrodes, the DEAP material alters from its first physical configuration (corresponding to a first dimensional size) to its second configuration (corresponding to a second dimensional size), with the difference between the first and second configurations being at least deformations in the direction against the clutch release plate 337 and in the direction against an opposite wall 341 of the body housing 303. In this example, the amount of deformation is sufficient to cause the clutch release plate 337 to displace the balls 323 toward the wide end 329 of the tapered clutch housing 321. The pin 309 may then be translated along the lateral axis 311, with respect to the receptacle 315, and removed from the body housing 303.

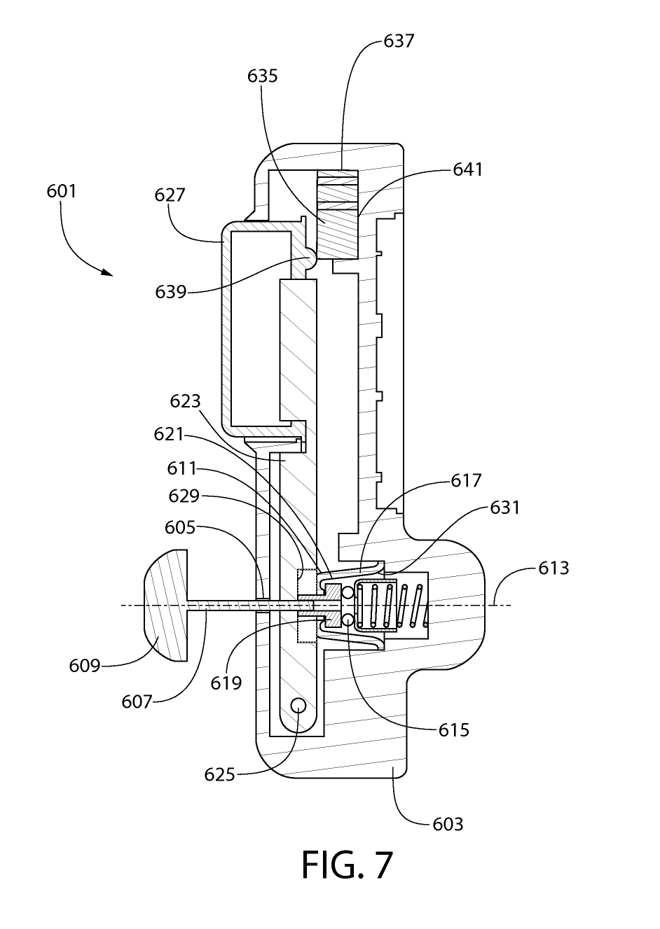

The security device 601 shown in FIG. 7 has a body housing 603 with a receptacle 605 for receiving a pin 607 from a pin assembly 609. A ball clutch mechanism 611 receives and engages the pin 607 as the pin 607 is inserted through the receptacle 605 along a lateral axis 613. The ball clutch mechanism 611 includes balls 615 inside a tapered clutch housing 617 and a clutch release plate 619, which extends from the interior to the exterior of the tapered clutch housing 617 at the narrow end 621 of the tapered clutch housing 617. A release lever 623 is placed within and coupled to the body housing 603 with a pivot pin 625, and a button portion 627 of the release lever 623 extends to the exterior of the body housing 603 so that it is accessible to, and may be pivoted by, a user. The bottom surface 629 of the release lever 623 abuts against the clutch release plate 619, so that when the release lever 623 is pivoted, the bottom surface 629 presses against the clutch release plate 619 to displace the balls 615 toward the wide end 631 of the tapered clutch housing 617. This disengages the balls 615 from the pin 607, so that the pin 607 may then be translated along the lateral axis 613, with respect to the receptacle 605, and removed from the body housing 603 with little effort. In this manner, the pin assembly 609 may be disengaged from the body housing 603, and therefore the pin assembly 609 may be disengaged from the article of merchandise.

Pivoting of the release lever 623 may be restricted by the electro-mechanical actuator 635 placed at the end of the release lever 623 opposite the pivot pin 625. The electro-mechanical actuator 635 is fixed to a first internal wall 637 of the body housing 603 and positioned so that part of it is placed between a shoulder 639 of the release lever 623 and a second internal wall 641 of the body housing 603 to prevent the release lever 623 from being pivoted. Similar to the security device of FIG. 1, upon being connected to the power source, the electro-mechanical actuator 635 alters from a first state to a second state. In the first state, the electro-mechanical actuator 635 has a first dimensional size (or alternatively, a first configuration) so that part of it extends to between the shoulder 639 of the release lever 623 and the second internal wall 641 of the body housing 603 to prevent pivoting of the release lever 623. In the second state, the electro-mechanical actuator 635 has a second dimensional size (or alternatively, a second configuration) so that it is at least partially retracted from between the shoulder 639 of the release lever 623 and the second internal wall 641 of the body housing 603, with the amount of retraction being sufficient to enable the release lever 623 to be pivoted by a user to the extent that the balls 615 are pushed away from the pin 607 to enable removal of the pin 607 from the receptacle 605.

The electro-mechanical actuator 635 may include an electro-active polymer element, as described above, which transforms from a first dimensional size to a second dimensional size. In certain other embodiments, other types of electromechanical actuators may be used to restrict pivoting of the electro-mechanical actuator 635. As indicated above, alteration of the electro-mechanical actuator 635 from the first state to the second state is achieved by connecting the electro-mechanical actuator 635 to an appropriate power source to supply an actuation voltage. The power source may be internal or external to the security device 601.

In certain embodiments, the security device 601 may include a switching circuit, having a signal receiver electrically coupled to a switch and to an antenna. As described above, when the antenna receives an appropriate wireless signal, the signal receiver actuates the switch. For embodiments having an internal power source, actuation of the switch electrically couples the power source to the electro-mechanical actuator. For embodiments having an external power source, actuation of the switch connects an electrical lead for the electro-mechanical actuator. The type of wireless signal that is appropriate for causing the signal receiver to actuate the switch is a matter of design choice. Examples of wireless signals include, but are not limited to, one that induces a passive resonant response to activate the signal receiver, such as are used in electronic article surveillance (EAS) security systems, or alternatively an RFID signal or RFID control signal.

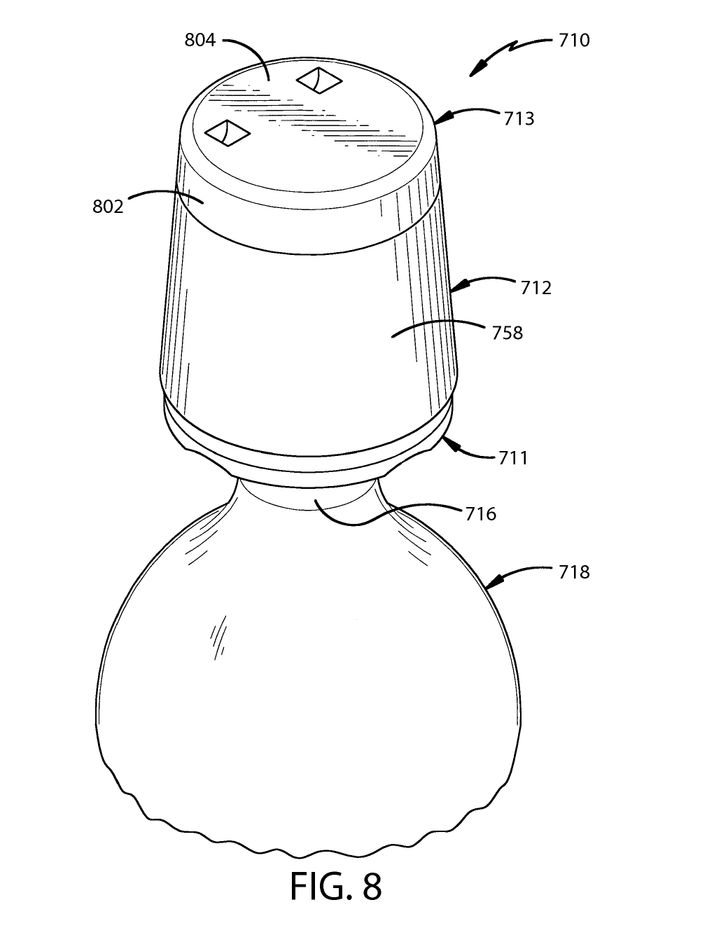

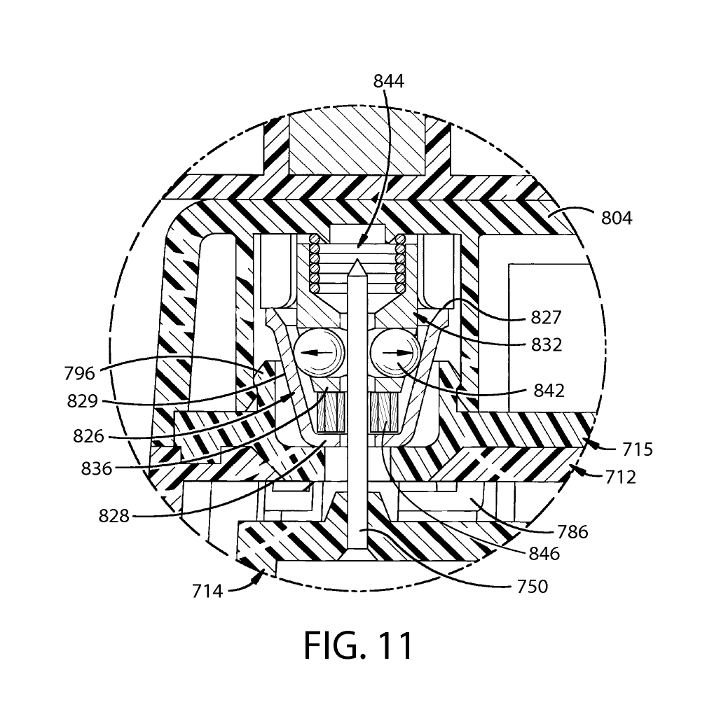

A bottle security device 710 is depicted in FIGS. 8-11. The bottle security device 710 generally includes an outer sleeve member 712, which serves as the body housing, an inner sleeve member 714, which serves as the coupler, and a locking mechanism that cooperate to lock the security device 710 on the neck 716 of a typical bottle 718. The locking mechanism is positioned above the top of the bottle and may be disposed intermediate the top of the inner sleeve member 714 and the top of the outer sleeve member 712. Preferably, no portion of the locking mechanism is disposed between respective side walls 729, 758 of the inner member 714 and the outer member 712. This configuration allows for a slimmer design of the bottle security device 710 and is also easier to mold. The outer sleeve member 712 may include an upper cap member 713. The inner sleeve member 714 includes pins 750 which are respectively engaged by the locking mechanism, which may be in the form of a ball clutch mechanism. The bottle security device 710 may also include a lower ring member 711 and an intermediate plate member 715. The bottle security device 710 may be locked on bottle neck 716 until actuation of an electro-mechanical actuator incorporated into the locking mechanism enables the inner sleeve member 714 to move with respect to the outer sleeve member 712.

The manner in which the bottle security device 710 operates is described in detail in U.S. Pat. No. 7,007,523, the disclosure of which is incorporated herein by reference in its entirety, and thus, some of those details are omitted here, particularly where they do not relate to the locking mechanism of the bottle security device 710.

The inner sleeve member 714 has an upper end 721, a lower end 725, and a substantially cylindrical or frustoconical side wall 729. The side wall 729 includes a body 722 substantially closed at the upper end 721 by a substantially circular end wall 724. A plurality of locking fingers 726 are cantilevered from the body 722 and extend downwardly therefrom toward the lower end 725. The locking fingers 726 are configured to fit over the bead typically included on a bottle neck. The locking fingers 726 may be sized to engage the bead and be forced radially outwardly when the inner sleeve member 714 is forced over the bead.

The inner sleeve member 714 also includes a plurality of connecting fingers 727, which like the locking fingers 726 are cantilevered from the body 722 and extend downwardly therefrom toward the lower end 725. The connecting fingers 727 may alternate with locking fingers 726. Each connecting finger 727 is configured to connect the inner sleeve member 714 to the lower ring member 711 by a snap-fit engagement.

The inner sleeve member 714 further includes a pair of opposed slots 742 in the body 722. The slots 742 extend parallel to the fingers 726, 727 above a respective pair of connecting fingers 727. A beveled entrance 744 to each slot 742 is defined by the end wall 724. The entrances 744 and the slots 742 aid in the connection of the inner sleeve member 714 to the outer sleeve member 712 by a snap-fit engagement.

The inner sleeve member 714 also includes a pair of cones 746, each of which defines a pinhole 748 which extends through the end wall 724. The pinholes 748 receive and house pins 750, the pins 750 being pointed upwardly to extend through the outer sleeve member 712 and the intermediate plate member 715 into the locking mechanism. The pins 750 are connected to the inner member 714 and have a tapered end 751 to facilitate their reception by the locking mechanism.

The lower ring member 711 is annular and configured to connect to the lower end 725 of the inner member 714 below the locking fingers 726 so as to surround a portion of the bottle neck when the bottle security device 710 is installed thereon. The lower ring member 711 is configured to connect to the connecting fingers 727 of the inner sleeve member 714 in a snap-fit engagement, thereby locking the lower ring member 711 to the inner sleeve member 714.

The outer sleeve member 712 defines a cavity and is generally configured to fit over the inner sleeve member 714 to substantially enclose the inner sleeve member 714 in cavity 765, such that the inner sleeve member 714 may not be readily viewed or accessed from outside bottle security device 710. The outer sleeve member 712 has a lower end 757 and an upper end 759 and includes a substantially cylindrical or frustoconical sidewall 758 bounded at the upper end 759 by a substantially circular end wall 760.

Within the cavity, the outer sleeve member 712 includes latches which are positioned to engage the slots 742 of the inner sleeve member 714. In sliding outer sleeve member 712 over inner sleeve member 714 to connect the two by a snap-fit engagement, the latches align with and engage the slots 742, with alignment of the latches and slots 742 serving to align the circular holes 774 in the outer sleeve member 712 with the pinholes 748 in the inner sleeve member 714.

The end wall 760 includes circular holes 774 which taper inwardly and downwardly through the end wall 760. The end wall 760 further includes a plurality of connecting slots 776 adjacent the side wall 758. Opposed tabs 778 extend into the slots 776 respectively from the side wall 758 and the end wall 760. Within a pair of slots 776, respective alignment ridges 780 extend between the side wall 758 and the end wall 760. The tabs 778 assist in connecting the outer sleeve member 712 to the intermediate plate member 715 by a snap-fit engagement. The ridges 780 facilitate alignment between the outer sleeve member 712 and the plate member 715.

The intermediate plate member 715 is a generally flat circular plate. A plurality of inserts 786 extend downwardly adjacent the perimeter of plate member 715 and define holes 788 for receiving the tabs 778 of the outer sleeve member 712, thereby connecting the outer sleeve member 712 to the plate member 715. Alignment notches 790 align with the ridges 780 of the outer sleeve member 712 for the purpose of aligning the holes 774 of the outer sleeve member 712 with the holes 794 of the intermediate plate member 715. A pair of cylinders 796 extend upwardly from the intermediate plate member 715 and concentrically surround holes 794.

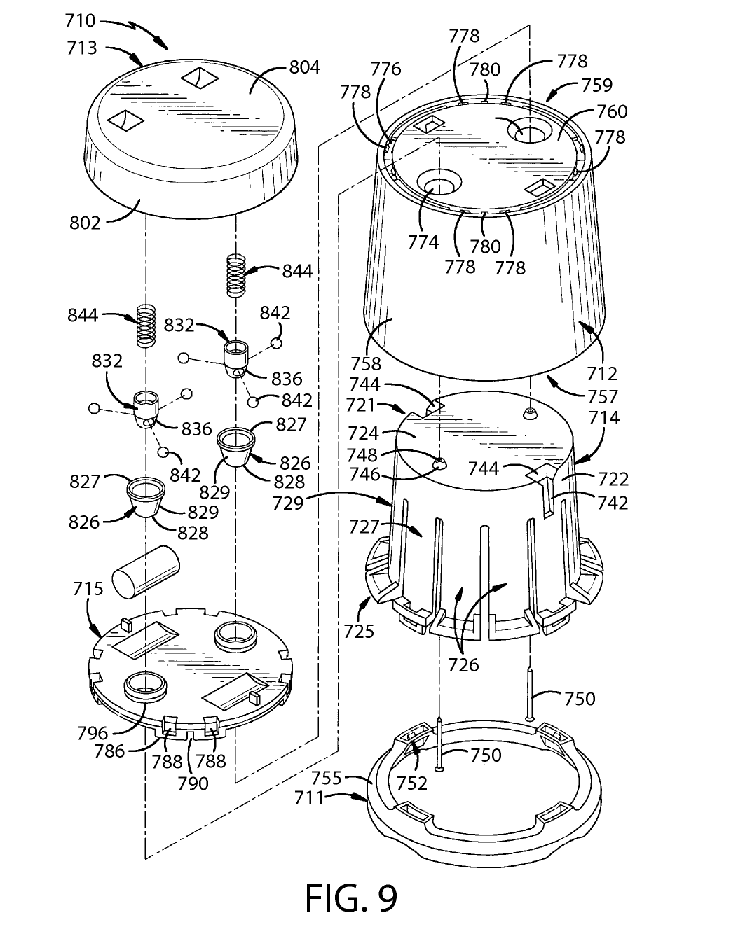

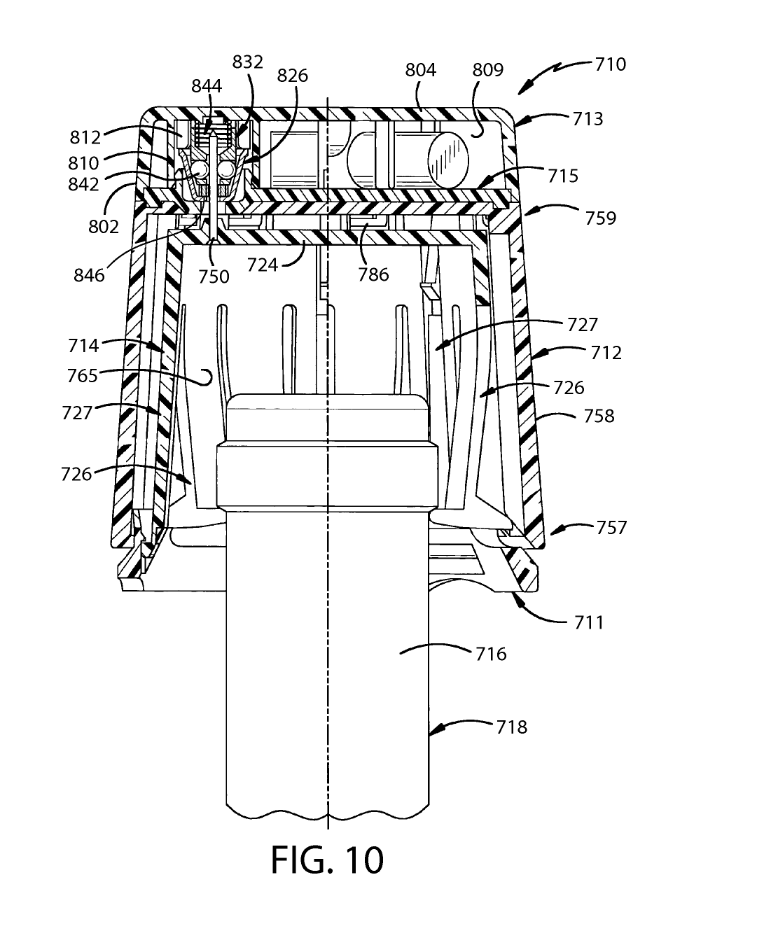

Referring to both FIGS. 9 and 10, the upper cap member 713 includes a substantially cylindrical or frustoconical annular side wall 802 and a substantially circular end wall 804. The cap member 713 is connected to the plate member 715 to form an enclosure 809 therebetween. The cap member 713 is also connected to outer member 712. A pair of cylinders 810 extend downwardly from the lower surface of the end wall 804 and are aligned with plate member cylinders 796 and configured to slide over and connect with the plate member cylinders 796. The cylinder 810 is configured to form a snap-fit engagement with the plate member cylinders 796.

The security device 710 further includes a ball clutch mechanism 825 as the locking mechanism housed within each of the cylinders 810. The ball clutch mechanism 825 includes a plurality of balls 842 arranged in a tapered clutch housing 826 such that there is space for the pin 750 to be inserted into the tapered clutch housing 826 amongst the balls 842. The inside walls 829 of the tapered clutch housing 826 are tapered slightly such that the inside diameter of the tapered clutch housing 826 is smaller at the wide end 827 than at the narrow end 828. A plunger 832 in the wide end 827 is biased toward the narrow end 828 of the tapered clutch housing 826 by a spring 844, forcing the balls 842 toward the inserted pin 750. The size of the balls 842 and the dimensions of the tapered clutch housing 826 are such that the balls 842 tightly press against the pin 750 when they are forced toward the narrow end 828 by the plunger 832 and the spring 844. The ball clutch mechanism 825 is thus able to maintain the pin 750 in a fixed position with respect to the outer sleeve member 712, and in doing so, the inner sleeve member 714 may remain in retaining engagement with the outer sleeve member 712, and thus also with the bottle.

The ball clutch mechanism 825 includes a clutch release plate 836. The clutch release plate 836 is positioned within the narrow end 828 of the tapered clutch housing 826. Displacement of the clutch release plate 836 toward the wide end 827 of the tapered clutch housing 826 displaces the balls 842 away from the narrow end 828 of the tapered clutch housing 826. As the balls 842 are displaced toward the wide end 827 of the tapered clutch housing 826, they do not tightly press against the pin 750, so that the pin 750 may then be removed from the tapered clutch housing 826, thereby allowing the inner sleeve member 714 to disengage from the outer sleeve member 712, and allowing the inner sleeve member 714 to be disengaged from the bottle.

The clutch release plate 836 may be displaced by an electro-active polymer element (EAP) 846. In other embodiments, as discussed above, other types of electromechanical actuators may be used to displace the clutch release plate 836. The EAP element 846 is positioned within tapered clutch housing 826, between the narrow end and the clutch release plate 836, so that it may displace the clutch release plate 836 upon connection to a power source. For example, leads may connect each electrode of the EAP element 846 to a power source that is either internal or external to the security device 710, with one of the leads being switched in a manner described above.

Although not shown in FIGS. 8-11, the bottle security device 710 may include a switching circuit, having a signal receiver electrically coupled to a switch and to an antenna. As described above, when the antenna receives an appropriate wireless signal, the signal receiver actuates the switch. For embodiments having an internal power source, actuation of the switch electrically couples the power source to the electro-mechanical actuator. For embodiments having an external power source, actuation of the switch connects an electrical lead for the electro-mechanical actuator. The type of wireless signal that is appropriate for causing the signal receiver to actuate the switch is a matter of design choice. Examples of wireless signals include, but are not limited to, one that induces a passive resonant response to activate the signal receiver, such as are used in electronic article surveillance (EAS) security systems, or alternatively an RFID signal or RFID control signal.

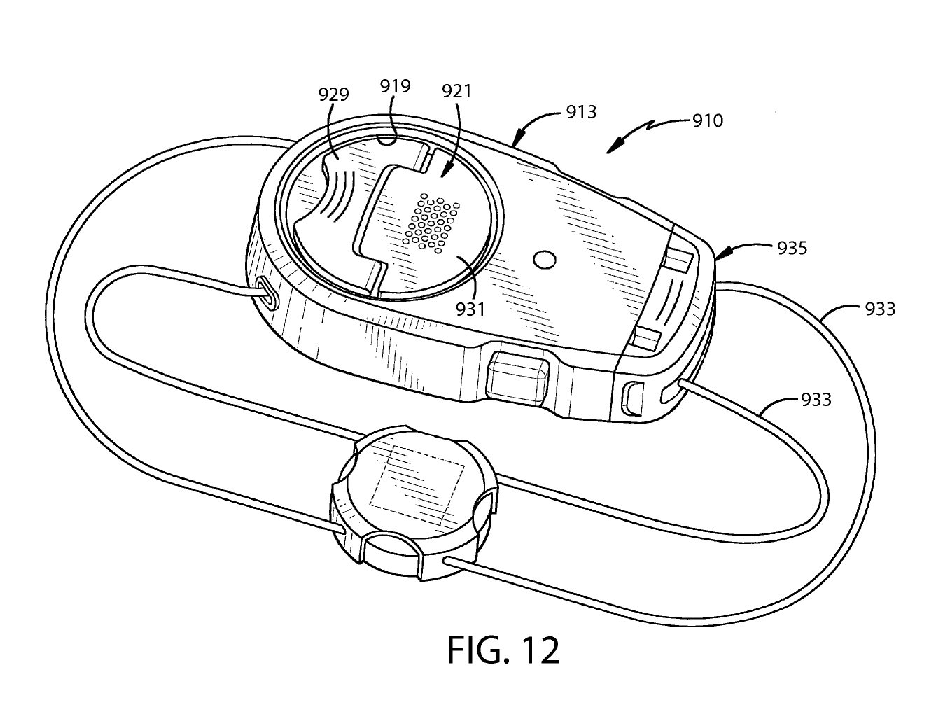

Another embodiment of a security device 910 is depicted in FIGS. 12-17. This security device 910 includes a body housing 913 forming an internal chamber having a spool compartment 916, in which is rotatably mounted a cable spool, and a lock compartment 918. The body housing 913 has an elongated configuration with a main circular opening 919 in which is rotatably mounted a winder mechanism 921. The winder mechanism 921 includes a flip-up handle 929 which is pivotally mounted on the main disc-shaped body portion 931 of the winder mechanism 921.

A cable 933 which could be a single loop, a pair of cables, or more, is connected to the spool with the other cable ends being connected to an attachment clip 935, which serves as a coupler for the security device 910. A locking mechanism, described below, is included within the body housing 913 of the security device 910. The cable 933 is stored on the spool, and the spool is biased to rotate in the winding direction to retract the cable onto the spool into a stored position. The manner in which the security device 910 operates is described in detail in U.S. Pat. No. 8,122,744, the disclosure of which is incorporated herein by reference in its entirety, and thus, some of those details are omitted here, particularly where they do not relate to the locking mechanism of the security device 910.

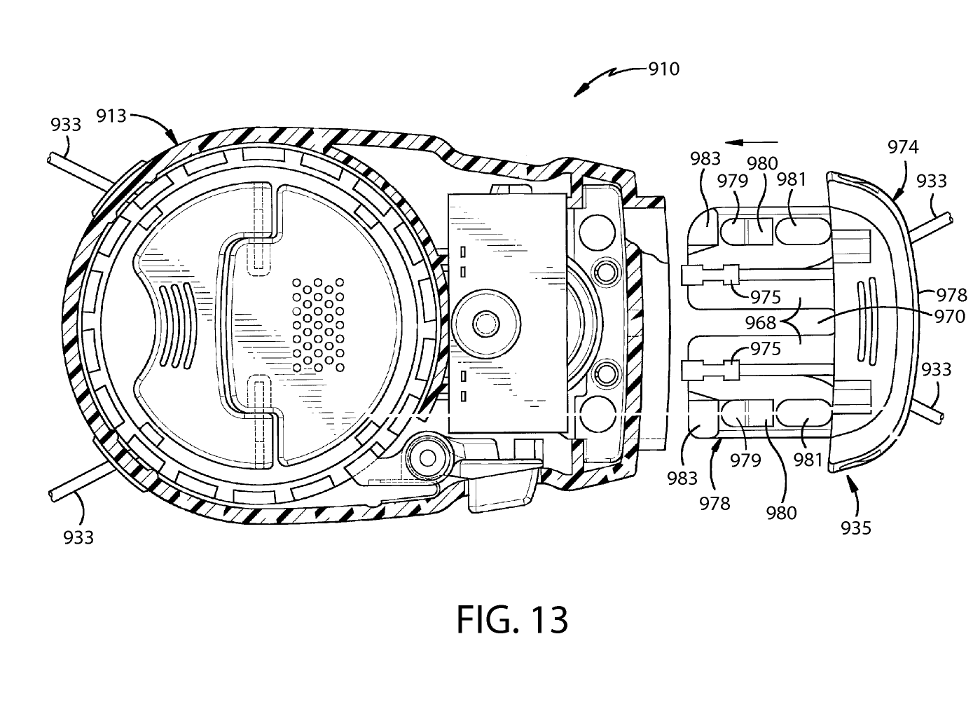

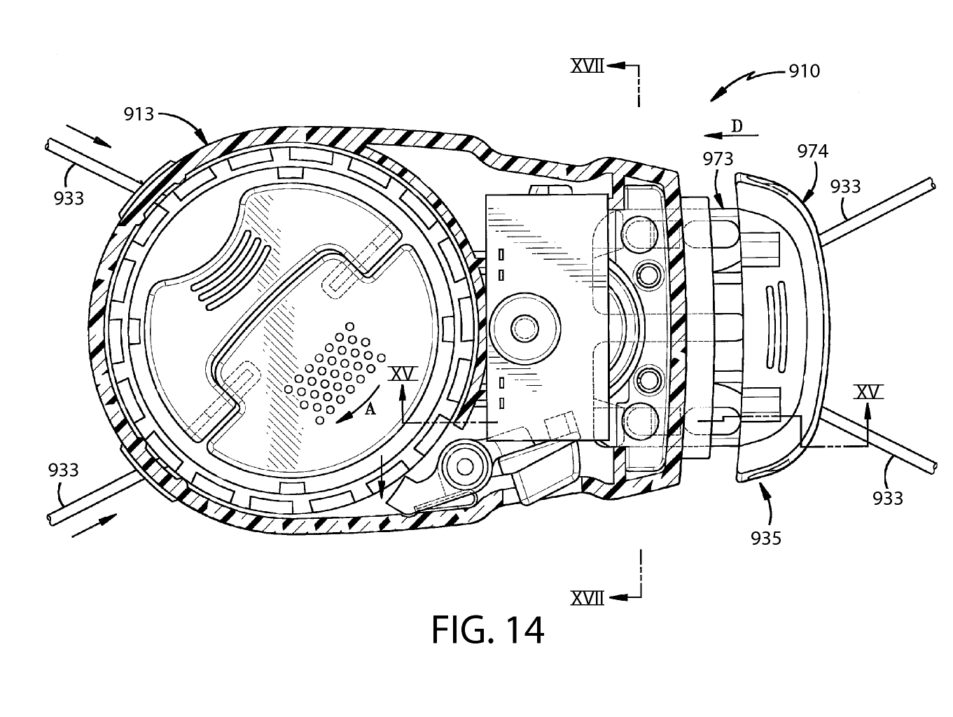

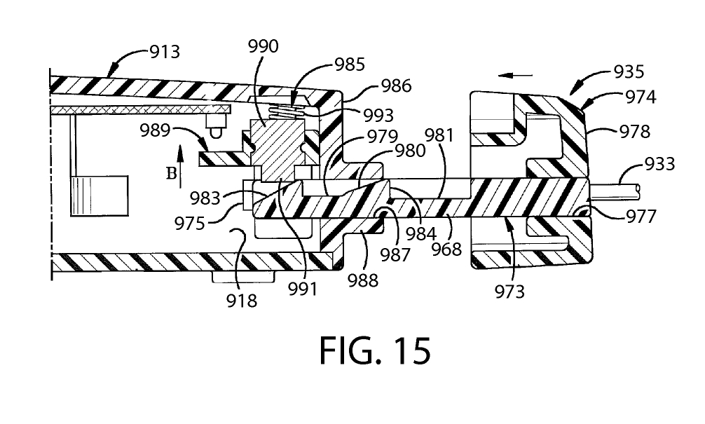

FIG. 13 shows the attachment clip 935 positioned for insertion into the body housing 913. The cable 933, at this point, would be wrapped around a piece of merchandise, to which the security device 910 is to be secured. FIGS. 14-15 shows the attachment clip 935 partially inserted into the body housing 913. Referring to FIGS. 13-15, the attachment clip 935 includes a locking clip 973 and a clip housing 974. The cables 933 are shown as being two cable sections which are secured in the locking clip 973 by a pair of metallic ferrules 975. The ferrules 975 are attached to the ends of the cables 933 and seated in compartments 967 formed in the clip 973 to secure the cables 933 in one end of the locking clip 973. The cables 933 extend outwardly through an elongated slot 977 formed in the end wall 978 of the clip housing 974. The locking clip 973 has a generally planar rectangular configuration and is divided by a slot 970 into a pair of legs 968. Each leg 968 is formed with a first pair of spaced recesses 979, each of which terminates in an upwardly extending tapered rear wall 980 opposite a right angled shoulder 984, and has a second pair of recesses 981 spaced rearwardly from the recess 979. The front edges of the locking clip legs 968 have tapered surfaces 983 adjacent the first pair of recesses 979.

A locking mechanism 985 is mounted at the attachment clip entrance end 986 of the body housing 913. The entrance end 986 is formed with a slotted opening 987 formed by an outwardly extending rectangular frame 988 for slidably receiving locking clip 973 therein. The locking mechanism 985 includes a locking shuttle 989 having a pair of spaced locking plungers 990 having end locking projections 991 which are engageable in the recesses 979, 981 of the locking clip 973 to dock the attachment clip 935 to the body housing 913. The locking plungers 990 are moveable away from the recesses 979, 981 independently of the locking shuttle 989, and movement of the locking shuttle 989 away from the recesses 979, 981 also moves the locking plungers 990 away from the recesses 979, 981. A pair of coil springs 993 are mounted about a pair of posts 995 which are formed integrally on the inside surface of the body housing 913 and which extend into aligned holes 997 formed in the locking shuttle 989. The springs 993 bias the locking shuttle 989, and in particular, the locking plunger ends 991 into locking engagement with the recesses 979, 981 of the locking clip 973.

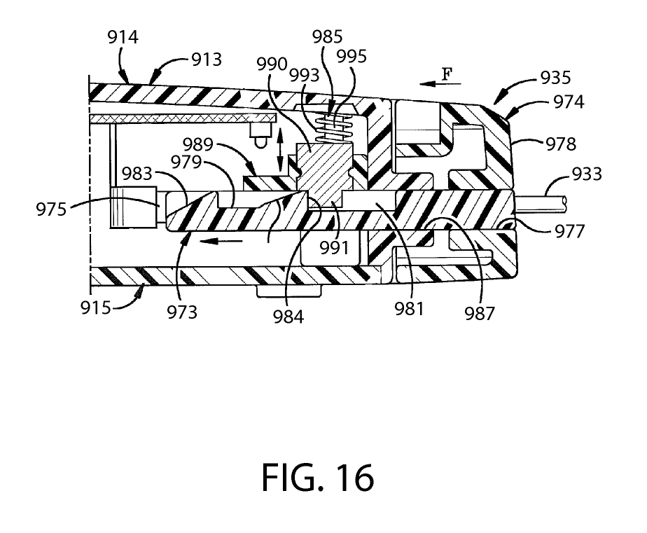

During use, the locking clip 973 is inserted into the body housing 913 into the locking position shown in FIG. 16. As the locking clip 973 is inserted into the body housing 913, the tapered or ramped ends 983 of the locking clip 973 move the locking plungers 990 from their downwardly biased position to a raised position. As the locking clip 973 is inserted further into the opening 987 of the body housing 913 to the locked position of FIG. 16, the locking plungers 190 are biased downwardly by the springs 993 into the second pair of recesses 981. When in this locked position, the locking clip 973 is prevented from being removed from the body housing 913. With the locking clip 973 in the locked position, the cables may be tensioned about the merchandise by the slack in the cables being taken up by the rotation of the spool.

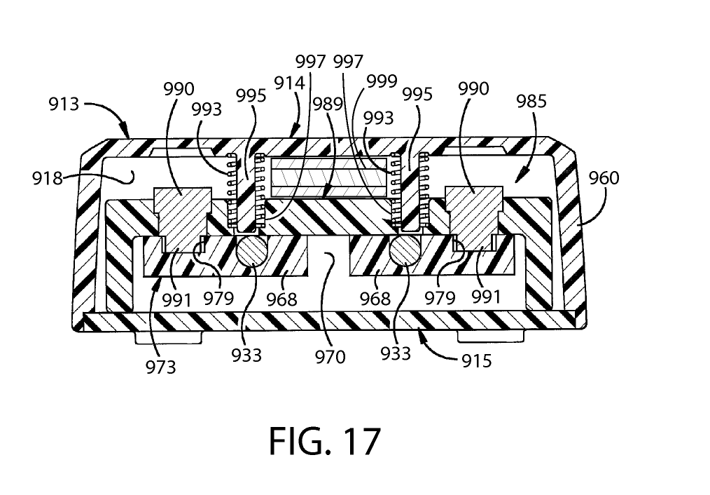

The locking shuttle 989 may be displaced by an electro-active polymer element (EAP) 999 connected between the locking shuttle 989 and the body housing 913, as shown in FIG. 17. Displacement of the locking shuttle 989, away from the locking clips 173, results in the locking plungers disengaging from the locking clips 173, thereby enabling the attachment clip 935 to be withdrawn from the body housing 913. In other embodiments, as discussed above, other types of electromechanical actuators may be used to displace the locking shuttle 989. The EAP element 999 may displace the locking shuttle 989 upon connection to a power source. For example, leads may connect each electrode of the EAP element 999 to a power source that is either internal or external to the security device 910, with one of the leads being switched in a manner described above.

Although not shown in FIGS. 12-17, the security device 910 may include a switching circuit, having a signal receiver electrically coupled to a switch and to an antenna. As described above, when the antenna receives an appropriate wireless signal, the signal receiver actuates the switch. For embodiments having an internal power source, actuation of the switch electrically couples the power source to the electro-mechanical actuator. For embodiments having an external power source, actuation of the switch connects an electrical lead for the electro-mechanical actuator. The type of wireless signal that is appropriate for causing the signal receiver to actuate the switch is a matter of design choice. Examples of wireless signals include, but are not limited to, one that induces a passive resonant response to activate the signal receiver, such as are used in electronic article surveillance (EAS) security systems, or alternatively an RFID signal or RFID control signal.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A security device comprising:
a body housing configured to receive a coupler to affix the body housing to an article of merchandise;
a locking mechanism configured to maintain the coupler in a fixed position with respect to the body housing and in retaining engagement with the article of merchandise; and
an electro-mechanical actuator configured to alter from a first state to a second state in response to application of an actuation voltage, wherein alteration of the electro-mechanical actuator from the first state to the second state enables the coupler to move with respect to the body housing.

2. The security device of claim 1, wherein the electro-mechanical actuator comprises an electro-active polymer element having a first dimensional size corresponding to the first state and a second dimensional size corresponding to the second state, the second dimensional size being different from the first dimensional size.

3. The security device of claim 1, wherein alteration of the electro-mechanical actuator from the first state to the second state disengages the coupler from the locking mechanism.

4. The security device of claim 1, wherein the electro-mechanical actuator comprises one of an electromagnetic actuator and a squiggle motor.

5. The security device of claim 1, further comprising a power source coupled to the electro-mechanical actuator through a switching circuit.

6. The security device of claim 5, wherein the switching circuit comprises a activation element configured to operatively connect the power source to the electro-mechanical actuator in response to receipt of a wireless signal.

7. The security device of claim 1, wherein the locking mechanism comprises a ball clutch mechanism having a plurality of balls disposed within a tapered clutch housing, the balls engaging the coupler received into the body housing at a narrow end of the tapered clutch housing to retain the coupler in the fixed position.

8. The security device of claim 7, wherein the locking mechanism further comprises a clutch release plate configured to be displaced in response to actuation of the electro-mechanical actuator, such that displacement of the clutch release plate displaces the balls away from the narrow end of the tapered clutch housing to enable the coupler to move with respect to the body housing.

9. The security device of claim 1, wherein the electro-mechanical actuator displaces the clutch release plate.

10. A method of detaching a security device from an article of merchandise, the method comprising:
directing a signal into the security device, the security device comprising:
a body housing;
a coupler engaged with the article of merchandise and received in the body housing;
a locking mechanism configured to maintain the coupler in a fixed position with respect to the body housing and in retaining engagement with the article of merchandise; and
an electro-mechanical actuator configured to alter from a first state to a second state, wherein alteration of the electro-mechanical actuator from the first state to the second state enables the coupler to move with respect to the body housing;
wherein the signal causes the electro-mechanical actuator to alter from the first state to the second state; and
disengaging the coupler from the article of merchandise.

11. The method of claim 10, wherein alteration of the electro-mechanical actuator from the first state to the second state disengages the coupler from the locking mechanism.

12. The method of claim 10, wherein directing a signal into the security device comprises directing a wireless signal into the security device, the security device further comprising an activation element configured to operatively couple the electro-mechanical actuator to a power source in response to receipt of the wireless signal.

13. The method of claim 10, wherein the electro-mechanical actuator comprises an electro-active polymer element having a first dimensional size corresponding to the first state and a second dimensional size corresponding to the second state, the second dimensional size being different from the first dimensional size.

14. The method of claim 10, wherein the locking mechanism comprises a ball clutch mechanism having a plurality of balls disposed within a tapered clutch housing, the balls engaging the coupler received by the body housing at a narrow end of the tapered clutch housing to retain the coupler in the fixed position.

15. The method of claim 14, wherein the locking mechanism further comprises a clutch release plate configured to be displaced in response to actuation of the electro-mechanical actuator, such that displacement of the clutch release plate displaces the balls away from the narrow end of the tapered clutch housing to enable the coupler to move with respect to the body housing.

16. A security device comprising:
a pin configured for engagement with an article of merchandise;
a body housing having a receptacle configured to receive the pin when the pin is engaged with the article of merchandise;
a locking mechanism configured to maintain the pin in a fixed position with respect to the receptacle and in retaining engagement with the article of merchandise; and
an electro-active polymer element configured to alter from a first dimensional size to a second dimensional size in response to application of an actuation voltage, the second dimensional size being different from the first dimensional size, wherein alteration of the electro-active polymer element from the first dimensional size to the second dimensional size enables the pin to translate along a lateral axis with respect to the receptacle.

17. The security device of claim 16, wherein alteration of the electro-active polymer element from the first dimensional size to the second dimensional size disengages the pin from the locking mechanism.

18. The security device of claim 16, further comprising a power source coupled to the electro-active polymer element through a switching circuit.

19. The security device of claim 16, wherein the locking mechanism comprises a ball clutch mechanism having a plurality of balls disposed within a tapered clutch housing, the balls engaging the pin received into the receptacle at a narrow end of the tapered clutch housing to retain the pin in the fixed position.

20. The security device of claim 19, wherein the locking mechanism further comprises a clutch release plate configured to be displaced in response to actuation of the electro-active polymer element altering from the first dimensional size to the second dimensional size, such that displacement of the clutch displaces the balls away from the narrow end of the tapered clutch housing to enable the pin to translate along the lateral axis with respect to the receptacle.
